(19) United States
(12) Patent Application Publication
(10) Pub. No.: US 2006/0090752 A1
(43) Pub. Date: May 4, 2006

(54) Method for determining drug dose for inhaled drug therapy

(75) Inventors: Anthony Rocco Imondi, Westerville, OH (US); David John Westaway, Grove City, OH (US)

Correspondence Address: DAVID J. WESTAWAY, PRESIDENT, ZIVENA, INC., P.O. BOX 16276, COLUMBUS, OH, 43216-6278, US

(73) Assignee: ZIVENA, INC.

(21) Appl. No.: 10/979,361

(22) Filed: Nov. 3, 2004

(51) Int. Cl. A62B 7/00

(52) U.S. Cl. 128/200.24; 128/200.14; 128/203.12

(57) ABSTRACT

The invention is directed to a method for determining the total amount of liquid medicament containing an active drug substance to be aerosolized and inhaled by a patient in order to deliver a pharmaceutically effective amount (“PEA”) of said drug to the respiratory tract of said patient comprising: A) aerosolizing a measured amount of said medicament liquid containing a known amount of drug (“Aerosolized Dose”) using an aerosolization means connected to said patient via an inhalation tube and an exhalation tube; wherein said exhalation tube contains a filter means and wherein said Aerosolized Dose is less than said PEA of said drug; B) administering said aerosol to the respiratory tract of said patient via said inhalation tube; C) allowing the patient to exhale through said exhalation tube containing said filter wherein any exhaled drug is trapped on said filter; D) measuring the reflectance of the color on the filter media contained in said exhalation filter using a reflectance spectrophotometer to determine the amount of drug on said exhalation filter (“Exhaled Dose”); E) determining the actual dose delivered to said patient (“Delivered Dose”) as follows: Aerosolized Dose minus Trapped Dose minus Exhaled Dose=Delivered Dose, where the Trapped Dose is the amount of drug trapped in the inhalation tube; and F) calculating the total amount of liquid medicament to be aerosolized (“Total Aerosolized Dose”) by multiplying the PEA by the result of dividing the Delivered Dose by the Aerosolized Dose; wherein a solution or suspension of the drug is colored when viewed by the human eye or wherein the drug reacts with a reagent on the filter media of said filter means to produce a color.

### BACKGROUND OF THE INVENTION

1. Field of the Invention

The field of the invention is directed to the determination of the dosage of a drug actually delivered to the respiratory tract of a patient via inhalation when the drug is administered as an inhaled aerosol.

2. Description of the Related Art

Many drugs, including many cytotoxic drugs, have a narrow therapeutic index (NTI) meaning that very small changes in the dosage level can cause toxic results. These drugs require constant patient monitoring so that the level of medication can be adjusted as necessary to assure uniform and safe results. When a NTI drug is administered via inhalation to treat a pulmonary disease, it is even more critical that the correct concentration of drug is administered to the patient. Since there is an inherent variability of pulmonary function among patients with pulmonary disease, a test method that can determine the amount of drug to be aerosolized and inhaled for the patient to achieve a specified dose of drug to the pulmonary tract of a patient being treated is very useful.

Haynam et al teaches an indirect test method (Tc 99 Deposition Test) that can determine the amount of a cytotoxic drug doxorubicin to be aerosolized and inhaled for a patient to achieve a specified dose of doxorubicin. (Proc Soc Nuclear Med. June, 2002.) The Tc 99 Deposition Test requires a patient to inhale an aerosolized solution of technetium (Tc 99m) pentetate or Tc 99m DTPA using the same aerosolization device and breathing pattern used for inhalation of aerosolized doxorubicin. The percentage of aerosolized Tc 99m retained by the patient is used to calculate the amount of aerosolized doxorubicin to be delivered.

Studies conducted in normal volunteers and in patients with respiratory impairment indicated that the Tc 99 Deposition Test was well-tolerated and yielded reproducible intrasubject results. However, the procedure is cumbersome and requires the use of nuclear medicine staff and facilities which precludes routine use of this test in an out-patient or clinic setting. Therefore, this test is usually conducted once at the beginning of therapy and as such also does not account for variations in the patient's pulmonary capacity throughout therapy.

### SUMMARY OF THE INVENTION

The invention is directed to a method for determining the amount of a drug to be aerosolized and inhaled for a patient to achieve a specified dosage of the drug in the pulmonary tract. An integral part of the method of the invention is the use of reflectance spectrophotometry to measure the reflectance of “colored” drugs.

### BRIEF DESCRIPTION OF DRAWINGS

Aspects of the methods of the invention are illustrated by the accompanying drawings. Eight sheets of drawings are provided. Sheet one contains FIG. 1. Sheet two contains FIG. 2. Sheet three contains FIG. 3 and FIG. 4 and Sheets four through ten contain FIG. 5-FIG. 9.

FIG. 1 illustrates the placement of the filter 5c in the exhalation tube 5.

FIG. 2 provides further details of the inhalation tube 4, exhalation tube 5 and mouthpiece 1.

FIG. 3 and FIG. 4 show views of the filter 5c and the sampling ports A-E.

FIG. 5-FIG. 9 are graphs of data reflecting the practice of the method of the invention as well as the accuracy and reproducibility of the invention method.

### DETAILED DESCRIPTION OF THE INVENTION

The present invention is directed to a method for determining the total amount of liquid medicament containing an active drug substance to be aerosolized and inhaled by a patient in order to deliver a pharmaceutically effective amount (“PEA”) of said drug to the respiratory tract of said patient comprising:
A) aerosolizing a measured amount of said medicament liquid containing a known amount of drug (“Aerosolized Dose”) using an aerosolization means connected to said patient via an inhalation tube and an exhalation tube; wherein said exhalation tube contains a filter and wherein said Aerosolized Dose is less than said PEA of said drug;
B) administering said aerosol to the respiratory tract of said patient via said inhalation tube;
C) allowing the patient to exhale through said exhalation tube containing said filter wherein any exhaled drug is trapped on said filter;
D) measuring the reflectance of the color on the filter media contained in said exhalation filter using a spectrophotometer to determine the amount of drug on said exhalation filter (“Exhaled Dose”);
E) determining the actual dose delivered to said patient (“Delivered Dose”) as follows: Aerosolized Dose minus Trapped Dose minus Exhaled Dose=Delivered Dose, where the Trapped Dose is the amount of drug trapped in the inhalation tube; and
F) calculating the total amount of liquid medicament to be aerosolized (“Total Aerosolized Dose”) by multiplying the PEA by the result of dividing the Delivered Dose by the Aerosolized Dose;
   wherein a solution or suspension of the drug is colored when viewed by the human eye or wherein the drug reacts with a reagent on the filter media of said filter means to produce a color.

As used herein the term “liquid medicament” refers to an active drug substance for use in human or animal patients that is dissolved or suspended in a pharmaceutically acceptable liquid carrier vehicle. The term “pharmaceutically acceptable liquid carrier” is used to mean a liquid in which the drug to be delivered is dissolved or suspended and which is acceptable for pulmonary administration of the drug to the respiratory tract of the patient. In addition to the drug the liquid carrier vehicle may optionally contain minor amounts of one or more pharmaceutically acceptable excipients. Various liquid carrier vehicles are described in the art for use in preparing formulations of drugs to be administered via inhalation; see for example U.S. Pat. No. 6,503,481, U.S. Pat. No. 6,105,571, and U.S. Pat. No. 5,660,166, the contents of which are herein incorporated by reference.

Pharmaceutically acceptable excipients are those recognized by the FDA as being safe for use in humans and animals. Additives such as, antioxidants, e.g., Vitamin E, Vitamin E TPGS (α-alpha tocopferol polyethylene glycol 1000 succinate), ascorbic acid, anti-microbials, e.g, parabens, pH adjusting agents, e.g., sodium hydroxide and hydrochloric acid, tonicity adjusting agents, e.g., sodium chloride and viscosity adjusting agents, e.g., polyvinyl pyrrolidone are contemplated for use herein. While the selection of any particular pharmaceutically acceptable excipient is within the skill of the art, the decision regarding whether to add an excipient and if so which one, will be made taking into account the purpose of the excipient in the liquid medicament formulation.

The term “respiratory tract” as used herein includes the upper airways, including the oropharynx and larynx, followed by the lower airways, which include the trachea followed by bifurcations into the bronchi and bronchioli. The upper and lower airways are called the conductive airways. The terminal bronchioli then divide into respiratory bronchioli, which then lead to the ultimate respiratory zone, the alveoli, or deep lung. Gonda, I. “Aerosols for delivery of therapeutic and diagnostic agents to the respiratory tract,” in Critical Reviews in Therapeutic Drug Carrier Systems, 6: 273-313, (1990). Usually, the deep lung, or alveoli, is the primary target of inhaled therapeutic aerosols for systemic delivery.

As used herein, the term “active drug substance” or “drug” refers to a biologically active agent that is administration by inhalation to human or animal patients for treatment of a disease or condition or to diagnose a disease or condition (diagnostic). Such active drug substances are administered to a patient in a “pharmaceutically effective amount”. The method of the invention is useful with any drug which is “colored” as described below and which can be administered to a patient via inhalation. However, the methods of the invention are particularly useful with drugs that have a narrow therapeutic index.

The method of the invention utilizes the inherent color of certain drugs in solution or suspension or on the ability of certain drugs to react with a reagent to produce a color. When a reflectance spectrophotometer is used to measure this color (the reflectance) the percent reflectance (“% Reflectance”) can be correlated with amount of drug in milligrams or micrograms.

Examples of drugs that are useful in the method of the invention include anthracycline anticancer agents such as doxorubicin, epirubicin, idarubicin and daunorubicin which are red powders and which produce a red color in solution or suspension. Other “colored” anticancer drugs include the anticancer drug mitoxantrone which is blue in solution or suspension and the experimental anticancer drug bisantrene which is orange in color.

The method of the invention may be used with drugs that do not produce a colored suspension or solution but that will react with a reagent to produce a color. In this case the filter media may be sprayed with a reagent which will react with the drug or medicament liquid to produce a color. For example, ninhydrin reacts with α-amino acids in peptides to produce a purple complex which maximally absorbs light at 570 nm. Iodine will react with amylose in certain carbohydrates to produce a blue/black color at 380-450 nm.

The instruction manual that is supplied by each manufacturer of reflectance spectrophotometers will contain instructions on calibrating the instrument prior to measurement of an unknown sample. In order to translate “% reflectance” to milligrams (mg) or micrograms (μg) of drug, a standard curve similar to the curve shown in FIG. 6, must be constructed for each drug measured. It is within the skill of the art to prepare such a standard curve.

As would be recognized by one skilled in the art, by “pharmaceutically effective amount” is meant an amount of a pharmaceutically active agent having a therapeutically relevant effect on the disease or condition to be treated. A therapeutically relevant effect relieves to some extent one or more symptoms of the disease or condition in a patient or returns to normal either partially or completely one or more physiological or biochemical parameters associated with or causative of the disease or condition. Specific details of the dosage of a particular active drug may be found in its labeling, i.e., the package insert (see 21 CFR § 201.56 & 201.57) approved by the United States Food and Drug Administration.

The term “aerosolization means” refers to a device that is capable of aerosolizing a liquid medicament and delivering the aerosol to the pulmonary tract of a patient in need of treatment. Such means are described in U.S. Pat. No. 6,269,810 and U.S. Pat. No. 6,705,316 the contents of which are herein incorporated. Reference is made to FIG. 2 (from U.S. Pat. No. 6,269,810) which is a plan view illustrating the overall structure of a pulmonary dosing system and especially the inhalation and exhalation elements of the aerosolization device described in U.S. Pat. No. 6,269,810.

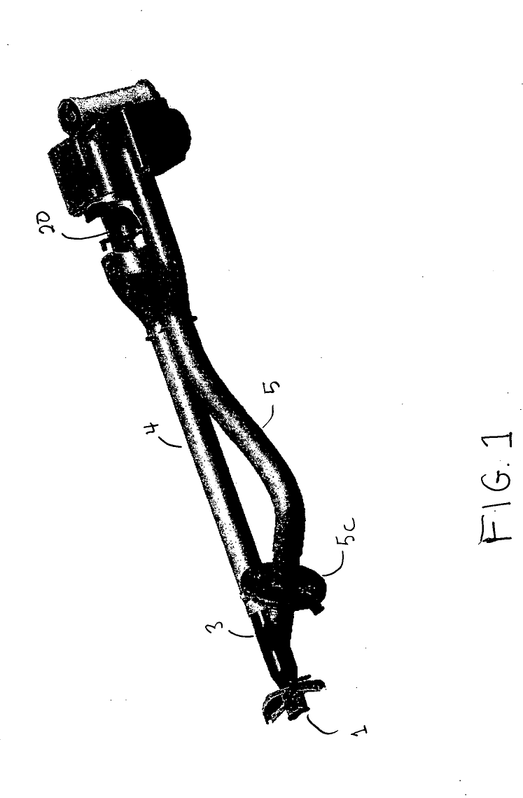

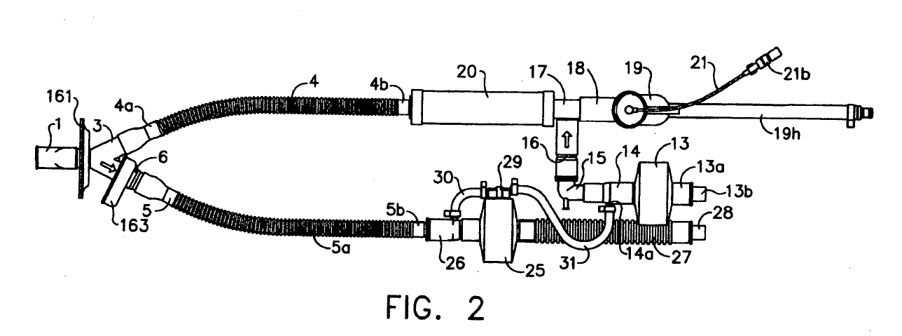

The inhalation/exhalation elements of the system illustrated by FIG. 1 and FIG. 2. includes a patient mouthpiece 1 to assist in containment of the aerosolized drug. The mouthpiece 1 is attached to a Y-adapter 3, having divergent legs 3a and 3b. An inhalation tube 4 is provided with an end 4a connected to the Y-adapter leg 3a. Similarly, an exhalation tube 5 has an end 5a connected to a check valve 6. The check valve 6, in turn, is connected to the leg 3b of Y-adapter 3. The purpose of the check valve is to assure that the patient will receive, via mouthpiece 1, only air and aerosolized drug from inhalation tube 4.

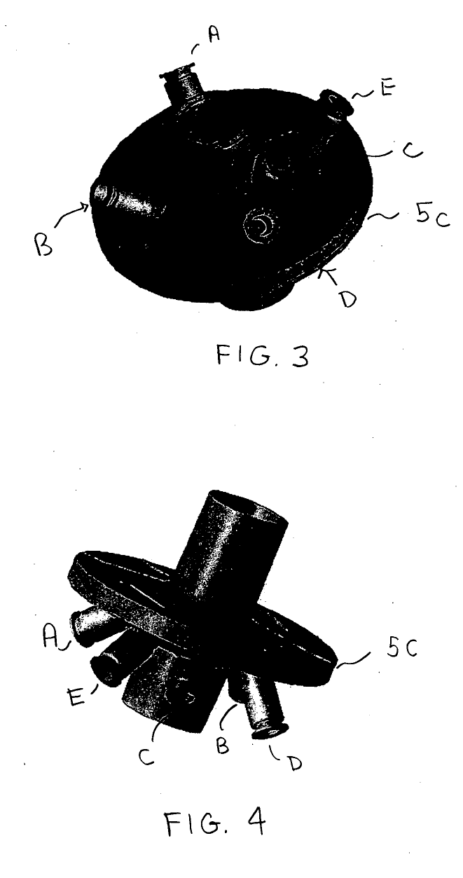

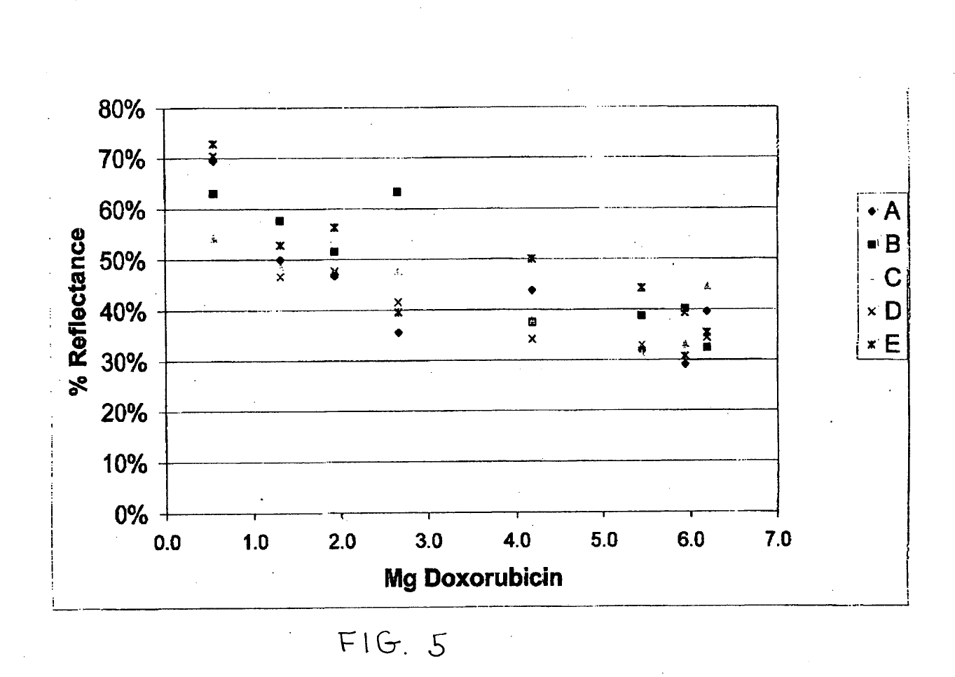

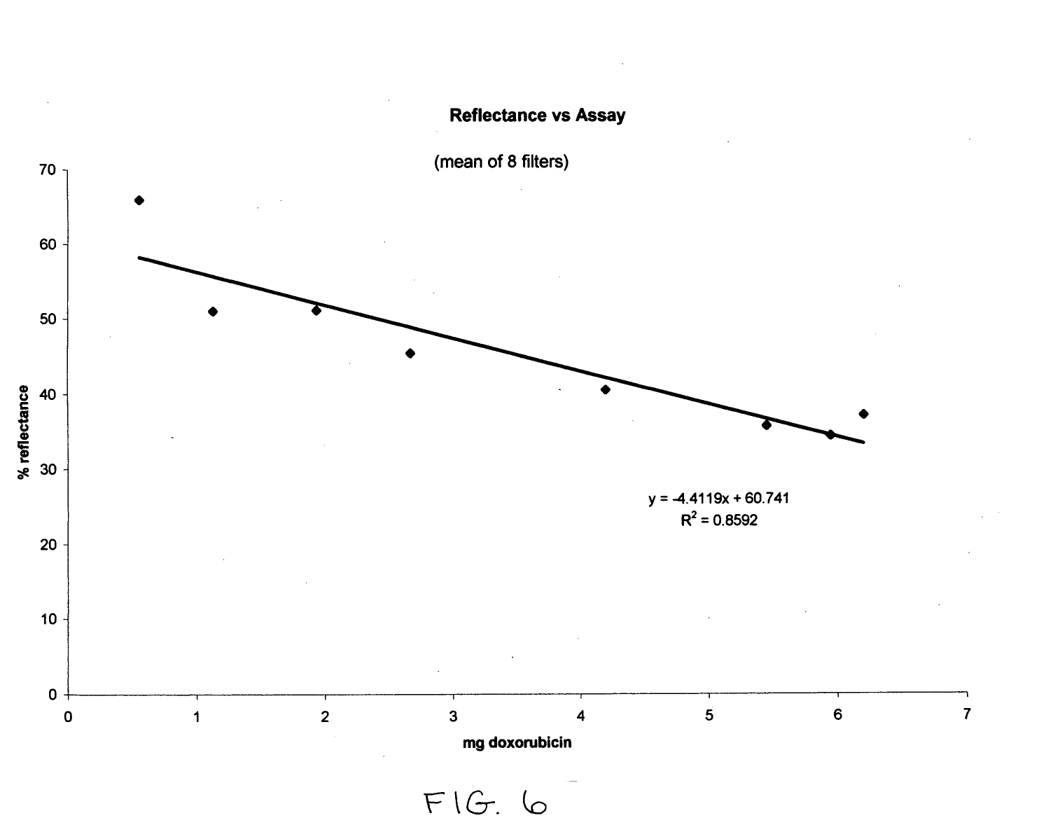

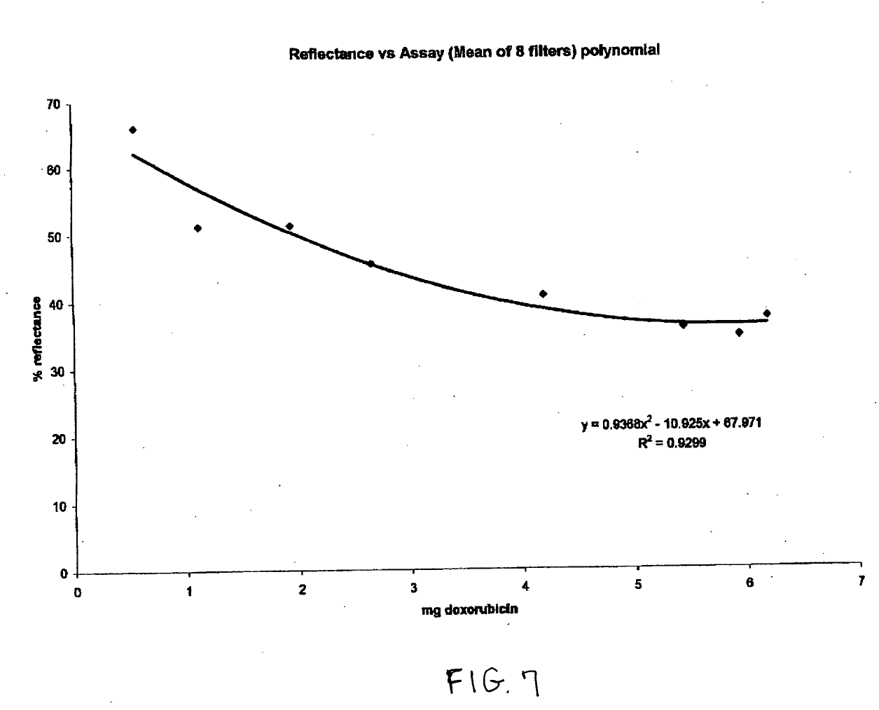

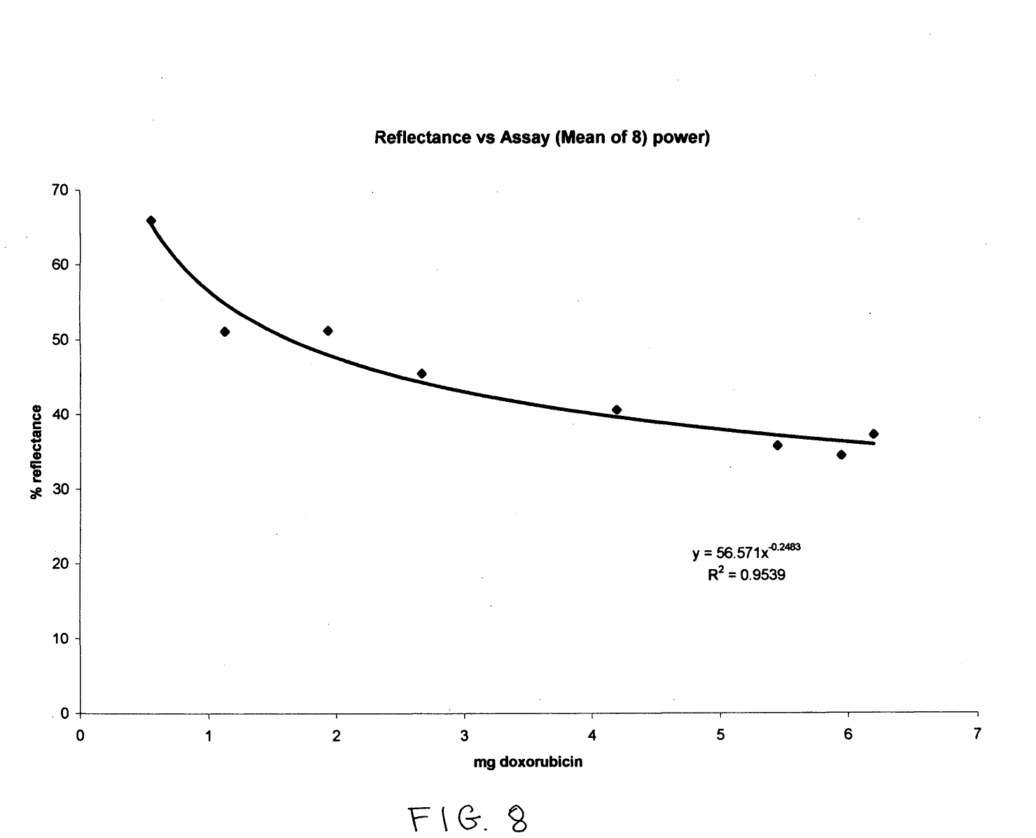

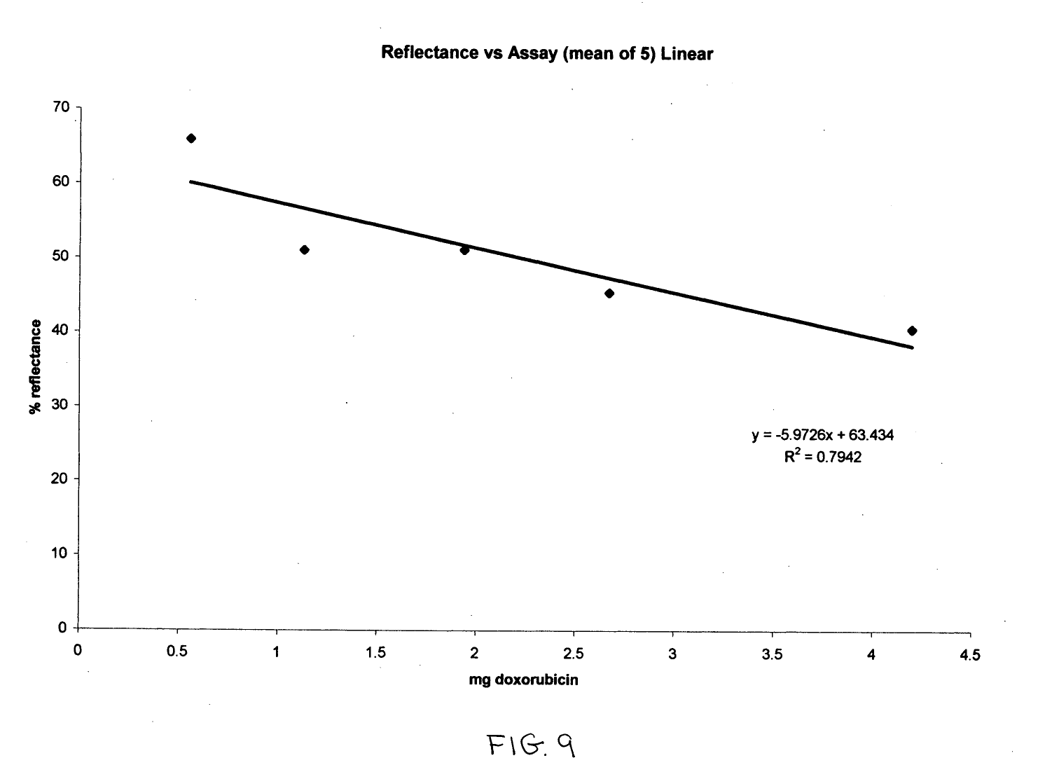

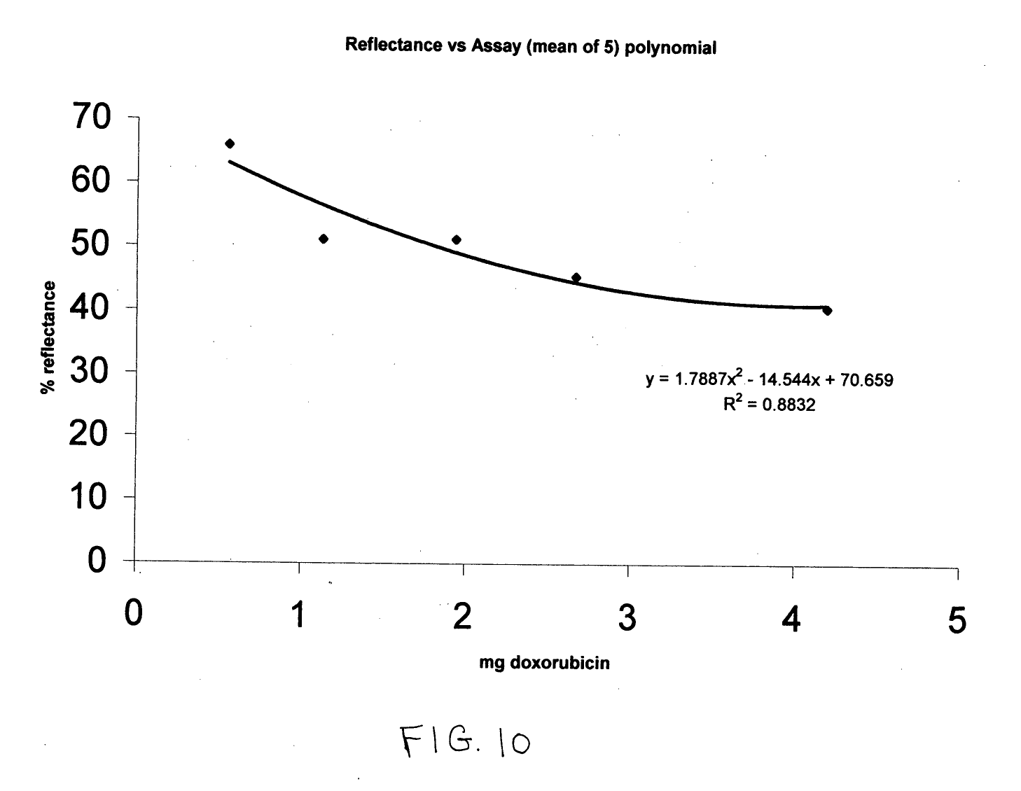

In the practice of the method of the invention, the filter 5c of FIG. 3 and FIG. 4 is inserted in the exhalation line 5 of FIG. 1. The filter is placed in the exhalation line so that the sampling ports A-E face the patient. The filter is composed of a filter body containing a filter medium. The filter body shown if FIG. 3 and FIG. 4, contains five ports for measurement of reflectivity labeled A-E. Position A is at the 12 o'clock position, Position B at 3 o'clock, position D at 6 o'clock and position E at 9 o'clock. Position C is at 4:30 but is closer to the center and the aerosol pathway. The filter body has a cylindrical opening on both sides of the filter body that allows for the filter body to be connected to the inhalation tube 4 of FIG. 1 or the exhalation tube 5 of FIG. 1. The filter shown in FIG. 3 and FIG. 4, has 5 ports for access by the fiber optic probe of the reflectance spectrophotometer; however, the filter need only have one port for sampling in order to practice the method described herein.

The filter body may be made of a variety of materials for example metal, rigid paper, or a plastic material; however, for convenience of manufacture and cost control it is preferred that the filter body be made out of an inexpensive moldable plastic material for example high impact polystyrene.

The filter media may be made of any filter material that allows air to travel through the filter medium and which will trap the drug. Since the filter is part of a disposable component it is important that the filter medium be inexpensive. A particularly useful filter media for use in the filter that is part of the disposable component of the aerosolization means is made of electret filter material manufactured by 3M Filtration Products a business unit of the 3M Company, 3M Corporate Headquarters, 3M Center, St. Paul, Minn. 55144-1000, U.S.A. and sold under the tradename Filtrete™. Filtrete medical filters may be custom designed to specifications for respiratory care or lung function equipment and are high efficiency, low pressure drop filters that assist in the protection of patients and equipment from cross contamination.

In the practice of the method of the invention a reflectance spectrophotometer is used to measure the amount of drug on the filter medium as a function of reflected light. A fiber optic probe which illuminates the surface of the filter medium and which also transmits the light reflected from the surface of the filter medium back to the spectrophotometer is inserted into any of ports A-E of the filter body.

Briefly, reflectance spectrophotometers measure the amount of light reflected by a surface as a function of wavelength to produce a reflectance spectrum. The operation of a reflectance spectrophotometer is basically to illuminate the sample with white light and to calculate the amount of light that is reflected by the sample at each wavelength interval. Typically data are measured for 31 wavelength intervals centered at 400 nm, 410 nm, 420 nm, . . . , 700 nm. This is done by passing the reflected light though a monochromating device that splits the light up into separate wavelength intervals. The instrument is calibrated using a white tile whose reflectance at each wavelength is known compared to a perfect diffuse reflecting surface. The reflectance of a sample is expressed between 0 and 1 (as a fraction) or between 0 and 100 (as a percentage).

Small reflectance spectrophotometers, many no bigger than a deck of cards are available from a variety of manufacturers, e.g., Ocean Optics, Inc., 830 Douglas Ave. Dunedin, Fla. 34698, USA. The reflectance spectrophotometer used to produce the data summarized in Table 1 was a S2000 Miniature Fiber Optic Spectrometer from Ocean Optics and is a low-cost, high-performance system easily configured for UV-VIS-Shortwave NIR applications from 200-1100 nm. One with skill in the inhalation therapy/medical arts will recognize that the choice of a particular reflectance spectrophotometer will be based on whether the equipment needs to be portable or is stationary, i.e., will it be used in a hospital, clinic or doctor's office and ease of use.

As illustrated by FIG. 1, the aerosol of the medicament liquid travels through inhalation tube 4 attached to Y-shaped connector/mouthpiece 3 and 1. Also connected to the Y-connector is exhalation tube 5. The inhalation tube, exhalation tube, filter and Y-connector/mouthpiece are a disposable unit. A new disposable unit is used when different patients are treated and at each treatment session of the same patient.

In practicing the method of the invention any drug that is lost in the inhalation tube 4 must be taken into account. The term “Trapped Dose” as used herein refers to the amount of drug which is lost in the in the inhalation tube 4 and Y-connector 3 of FIG. 1 and FIG. 2. It is important that the Trapped Dose be determined for each different device used in the method of the invention. As would be recognized by one skilled in this art, the amount of Trapped Dose will vary depending on the length of the inhalation tube 4, the configuration of the plenum 20 and the specific device used to produce the aerosol. Once the Trapped dose is calculated for a particular device and disposable component and assuming that the disposable components are manufactured to a predetermined specification, it is not necessary to determine the Trapped Dose every time one practices the method of the invention using a particular configuration of disposable and reusable aerosolization means.

The Trapped Dose may be measured as follows:

### Determination of Trapped Dose

A) The Operator (nurse or respiratory therapist) inserts a filter into the inhalation tube 4 of the disposable circuit (components). Sampling port side of the filter should face plenum 20 of FIG. 1 with the opposite side attached to the inspiratory side of patient Y-connector 3. Sampling port side of the filter is connected to the inhalation tubing with Position A upright (i.e., 12'oclock position).
B) The aerosolization device is turned on and the Operator coaches the patient through several deep breaths (5 deep breaths have been found to be satisfactory) of a known amount of drug contained in the aerosolized medicament liquid (“Initial Drug Dose”).
C) The reflectance of the drug trapped on the filter media is measured using a reflectance spectrophotometer to ascertain the amount of drug caught on the filter (the “Filter Drug Dose”).
D) The Initial Drug Dose minus the Filter Drug Dose equals the amount of drug trapped in the plenum and inhalation tube (the “Trapped Dose”).

The reproducibility and accuracy of the method of the invention was validated as described below. The nebulizer (aerosolization device) used in the validation methods described below was a Pari LC 2 reusable nebulizer available from PARI Respiratory Equipment, Inc., 2943 Oak Lake Boulevard, Midlothian, Va. 23112, USA (1-800-327.8632), email: productinfo@pari.com.

### Validation of the Method of the Invention

The method of the invention was tested under laboratory conditions to insure its validity. The cytotoxic drug doxorubicin HCl which is a red powder and is red in solution or suspension was used in this test. Two laboratory sites, Lovelace Respiratory Research Institute (LRRI), Albuquerque N. Mex., and the Center for Advanced Drug Development at The University of Iowa (Iowa) were used. Aerosolization of doxorubicin, collection of doxorubicin on filters and reflectance measurement of the filters were performed by LRRI. Elution and HPLC assay of the doxorubicin from the filters were performed by Iowa. The activities performed at LRRI were conducted under Good Laboratory Practices (21CFR Part 58). The analyses conducted by Iowa were performed according to Good Laboratory Practices and to Current Good Manufacturing Practices (21 CFR Parts 58, 210 and 211).

At LRRI the aerosolization and drug delivery equipment was set up and used to deliver a variable number of 4 second pulses of doxorubicin HCl inhalation solution from the standard disposable component (DC) used in the clinical trials. This DC comprises a Pari LC 2 nebulizer, a plenum, and delivery tubing. A proprietary filter holder containing a filter media (together the filter) was placed at the end of the delivery tube. Immediately behind this filter was placed a second (back-up) filter to catch any leakage through the primary filter.

A series of 8 filters was used to collect increasing quantities of doxorubicin by increasing the number of aerosol pulses collected on each filter as shown in Table 1. After collecting the doxorubicin on each filter, the reflectivity of light at 570 nm wavelength was determined using an Ocean Optics Spectrometer and comparing with a red and white standard. The filter holder has five ports for measurement of this reflectivity labeled A-E. Position A was half way to the edge of the filter at the 12 o'clock position, Position B at 3 o'clock, position D at 6 o'clock and position E at 9 o'clock. Position C is at 4:30 but is closer to the center and the aerosol pathway. These measurements were recorded.

After recordation of the measurements, the filters were removed, placed in plastic bags with desiccant and stored under refrigeration at LRRI until sent to Iowa for analysis. They were shipped under ambient temperature conditions using FedEx priority overnight service to Iowa. There was very little moisture in the filter when stored in this manner and the loss of doxorubicin during transit was minimal. At Iowa the doxorubicin was extracted from the filters and measured quantitatively using chromatographic methods. StatMost version 2.5 (DataMost Corporation, Salt Lake City, Utah) was used to perform an analysis of variance on the reflectance data. Regression analysis on the reflectance/assay results was conducted using Microsoft Excel.

Assay of the back-up filters showed that while a very small amount of doxorubicin did escape the initial filter it was not sufficient to impact the results of the study (on three back-up filters used for a total of 55 pulses, a total of 14.3 micrograms was recovered, i.e., an average of 0.26 micrograms per pulse or less than 0.05% of the amount/pulse on the primary filters).

During the initial 10-pulse series, a flaw was encountered with position D of the filter holder which did not allow proper positioning of the spectrometer probe so this series of pulses was repeated.

The results of the reflectance and HPLC assays on the filters are shown in the Table 1 below. Reflectance readings of the reference standard for each filter were recorded and varied from 13.741 to 14.548. No correction for the reference standard readings was made to the reflectance readings for the filters.

A scatter plot of the reflectance vs assay data is presented in FIG. 5 and shows an overall decrease in reflectance with increasing amounts of doxorubicin per filter.

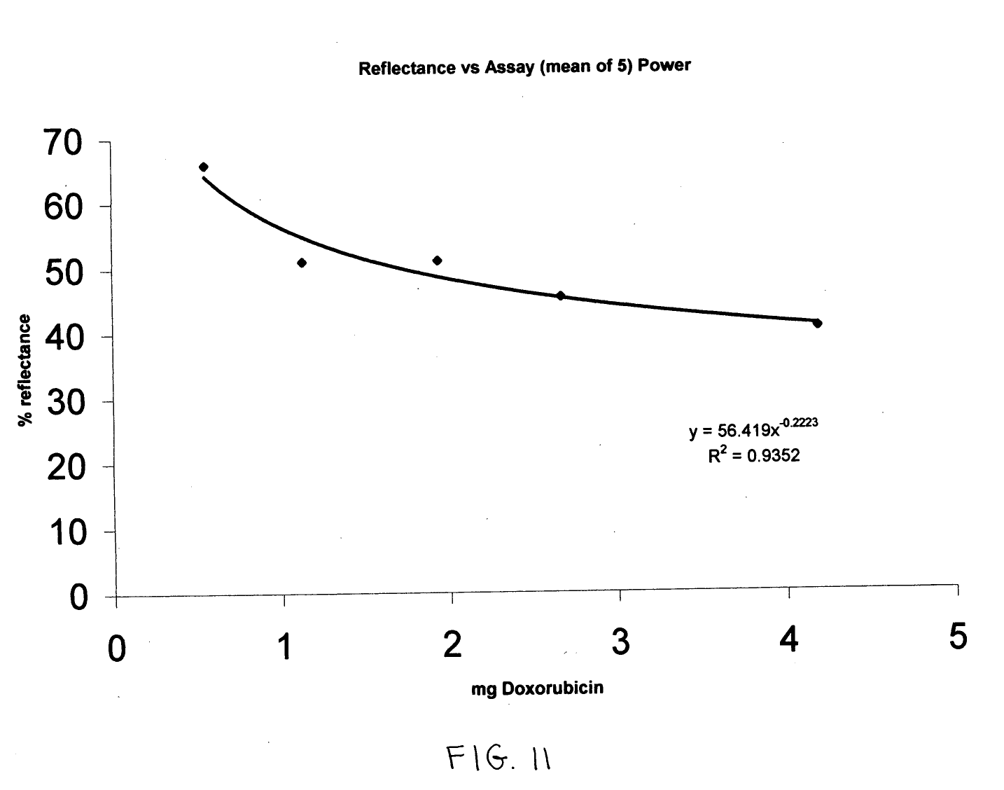

A two-way analysis of variance of the 5 port positions and the series of 8 filters having increasing amounts of doxorubicin showed a highly significant (P<0.001) inverse relationship between the mg doxorubicin/filter and the % reflectance. The differences among the mean reflectances for the 5 positions was not significant (P=0.34). The mean reflectance values of the 5 positions for each series of filters was plotted against the amount of doxorubicin assayed per filter. Using the mean reflectance data for the 8 filters which contained from 0.555 to 6.196 mg doxorubicin, the R² values were 0.86, 0.93 and 0.95 for linear, polynomial and power correlations, respectively (FIG. 68). Since the expected amounts of doxorubicin to be collected on the filter during patient testing is less than 4 mg, the mean reflectance data for the first 5 filters which contained from 0.555 to 4.193 mg doxorubicin were plotted separately against the mg doxorubicin per filter. The R² values were 0.79, 0.88 and 0.94 for the linear, polynomial and power correlations (FIG. 9-10).

TABLE 1
Reflectance (%) and Assay (μg) Doxorubicin on Filters

| | | Iowa- | | | | | | |
|---|---|---|---|---|---|---|---|---|
| Number | | measured | Reference | Position | Position | Position | Position | Position |
| of | | Doxorubicin | Standard | A | B | C | D | E |
| Pulses | | (μg) | Reflectance (%) | % | % | % | % | % |
| 1 | Pulse | 555.5 | 14.416 | 69.448 | 63.101 | 54.236 | 70.393 | 72.774 |
| 2 | Pulses | 1313.0 | 14.496 | 49.925 | 57.733 | 48.591 | 46.631 | 52.824 |
| 3 | Pulses | 1938.2 | 14.548 | 46.698 | 51.517 | 53.963 | 47.683 | 56.323 |
| 4 | Pulses | 2669.7 | 13.826 | 35.602 | 63.295 | 47.611 | 41.56 | 39.565 |
| 6 | Pulses | 4192.9 | 13.741 | 43.761 | 37.485 | 37.82 | 34.116 | 50.006 |
| 8 | Pulses | 5446.6 | 14.355 | 31.844 | 38.782 | 31.236 | 32.92 | 44.229 |
| 9 | Pulses | 5944.0 | 14.301 | 29.099 | 40.194 | 33.112 | 39.268 | 30.716 |
| 10 | Pulses* | | 14.446 | 30.464 | 25.381 | 33.072 | 13.044 | 37.648 |
| 10 | Pulses | 6196.2 | 14.113 | 39.517 | 32.385 | 44.565 | 34.349 | 35.435 |

*This measurement was omitted from further analysis because of the flaw at position D that did not enable correct placement of the probe.

The results of the study summarized in Table 1, indicate that the inhalation device used produced a reasonably constant amount of doxorubicin per pulse of approx 650 μg per pulse at the mouthpiece wth a standard deviation of 44 μg (6.8%). The results also demonstrate a strong inverse relationship between the actual amounts of doxorubicin deposited on the filters and the reflectance measurements of the doxorubicin-containing filters. Overall, there was no difference among the 5 detection ports (A-E) with respect to the reflectance measurements. The relationship between mean % reflectance and actual quantity of doxorubicin on the filters was described best by a non-linear correlation, in particular, where y=56.571x^{-0.2483}.

The invention and the manner and process of using it, are now described in such full, clear, concise and exact terms as to enable any person skilled in the art to which it pertains, to make and use the same. It is to be understood that the foregoing describes preferred embodiments of the present invention and that modifications may be made therein without departing from the spirit or scope of the present invention as set forth in the claims. To particularly point out and distinctly claim the subject matter regarded as invention, the following claims conclude this specification.

What is claimed:

1. A method for determining the total amount of liquid medicament containing an active drug substance to be aerosolized and inhaled by a patient in order to deliver a pharmaceutically effective amount (“PEA”) of said drug to the respiratory tract of said patient comprising:
A) aerosolizing a measured amount of said medicament liquid containing a known amount of drug (“Aerosolized Dose”) using an aerosolization means connected to said patient via an inhalation tube and an exhalation tube; wherein said exhalation tube contains a filter and wherein said Aerosolized Dose is less than said PEA of said drug;
B) administering said aerosol to the respiratory tract of said patient via said inhalation tube;
C) allowing the patient to exhale through said exhalation tube containing said filter wherein any exhaled drug is trapped on said filter;
D) measuring the reflectance of the color on the filter media contained in said exhalation filter using a reflectance spectrophotometer to determine the amount of drug on said exhalation filter (“Exhaled Dose”);
E) determining the actual dose delivered to said patient (“Delivered Dose”) as follows: Aerosolized Dose minus Trapped Dose minus Exhaled Dose=Delivered Dose, where the Trapped Dose is the amount of drug trapped in the inhalation tube; and
F) calculating the total amount of liquid medicament to be aerosolized (“Total Aerosolized Dose”) by multiplying the PEA by the result of dividing the Delivered Dose by the Aerosolized Dose;
wherein a solution or suspension of the drug is colored when viewed by the human eye or wherein the drug reacts with a reagent on the filter media of said filter means to produce a color.

2. The method according to claim 1 wherein said active drug substance is selected from the group consisting of doxorubicin, epirubicin, idarubicin, daunorubicin, mitoxantrone, and bisantrene.

3. The method according to claim 2 wherein said active drug substance is doxorubicin.

4. The method according to claim 2 wherein said active drug substance is epirubicin.

5. The method according to claim 2 wherein said active drug substance is idarubicin.

6. The method according to claim 2 wherein said active drug substance is daunorubicin.

7. The method according to claim 2 wherein said active drug substance is mitoxantrone.

8. The method according to claim 2 wherein said active drug substance is bisantrene.

9. The method according to claim 2 wherein said active drug substance is epirubicin

10. The method according to claim 1 wherein said material is electrete filter media.

11. The method according to claim 1 wherein said filter media contains a reagent that reacts with said drug to produce a color visable to the human eye

12. The method according to claim 1 wherein said aerosolization means is a nebulizer.

13. The method according to claim 1 wherein said Trapped Dose is determined as follows:
i) insert a filter a filter into inhalation tube 4 with the sampling port side of the said filter facing the plenum 20 with the opposite side attached to the inspiratory side of patient Y-connector 3 and where the sampling port side of said filter is connected to the inhalation tube with Position A upright;
ii) with the aerosolization device turned on, said patient takes a predetermined number of deep breaths of a known amount of drug contained in said aerosolized medicament liquid (“Initial Drug Dose”);
iii) the reflectance of the drug trapped on the filter media is measured using a reflectance spectrophotometer to determine the amount of drug caught on the filter (the “Filter Drug Dose”); and
iv) the Initial Drug Dose minus the Filter Drug Dose equals the Trapped Dose.

14. A method according to claim 13 wherein said predetermined number of deep breaths is from 5 to 10 deep breaths.

15. A method according to claim 14 wherein said predetermined number of deep breaths is 5.

16. A method for determining the total amount of liquid medicament containing an active drug substance to be aerosolized and inhaled by a patient in order to deliver a pharmaceutically effective amount (“PEA”) of said drug to the respiratory tract of said patient comprising:
A) aerosolizing a measured amount of said medicament liquid containing a known amount of drug (“Aerosolized Dose”) using an aerosolization means connected to said patient via an inhalation tube and an exhalation tube; wherein said exhalation tube contains a filter means; wherein said Aerosolized Dose is less than said PEA of said drug;
B) administering said aerosol to the respiratory tract of said patient via said inhalation tube;
C) allowing the patient to exhale through said exhalation tube containing said filter wherein any exhaled drug is trapped on said filter;
D) measuring the reflectance of the color on the filter media contained in said exhalation filter using a reflectance spectrophotometer to determine the amount of drug on said exhalation filter (“Exhaled Dose”);
E) determining the actual dose delivered to said patient (“Delivered Dose”) as follows: Aerosolized Dose minus Trapped Dose minus Exhaled Dose=Delivered Dose, where the Trapped Dose is the amount of drug trapped in the inhalation tube; and
F) calculating the total amount of liquid medicament to be aerosolized (“Total Aerosolized Dose”) by multiplying the PEA by the result of dividing the Delivered Dose by the Aerosolized Dose;
wherein a solution or suspension of the drug is colored when viewed by the human eye or wherein the drug reacts with a reagent on the filter media of said filter means to produce a color and wherein said Trapped Dose is determined as follows:
i) insert a filter into inhalation tube 4 with the sampling port side of said filter facing plenum 20 with the opposite side attached to the inspiratory side of patient Y-connector 3 and where the sampling port side of said filter is connected to the inhalation tube with Position A upright;
ii) with the aerosolization device turned on, said patient takes a predetermined number of deep breaths of a known amount of drug contained in said aerosolized medicament liquid (“Initial Drug Dose”);
iii) the reflectance of the drug trapped on the filter media is measured using a reflectance spectrophotometer to determine the amount of drug caught on the filter (the “Filter Drug Dose”); and
iv) the Initial Drug Dose minus the Filter Drug Dose equals the Trapped Dose.
